(19) United States
(12) Patent Application Publication
(10) Pub. No.: US 2023/0208050 A1
(43) Pub. Date: Jun. 29, 2023

(54) DUAL-FEED PATCH DIVERSITY ANTENNA

(71) Applicant: RF Venue, Inc., Walpole, MA (US)

(72) Inventors: Robert J. Crowley, Sudbury, MA (US); Caleb W. Morrison, Canton, MA (US); Charles Fendrock, Sudbury, MA (US)

(21) Appl. No.: 18/085,662

(22) Filed: Dec. 21, 2022

Related U.S. Application Data
(60) Provisional application No. 63/292,258, filed on Dec. 21, 2021.

(51) Int. Cl. H01Q 21/24; H04B 7/08

(52) U.S. Cl. CPC H01Q 21/24; H04B 7/0825; H01Q 1/24

(57) ABSTRACT

A diversity antenna for transmitting and/or receiving radio frequency (RF) signals includes a planar dielectric substrate on which is disposed a single conductive patch and a pair of conductive feeds, each conductive feed extending into the patch using an inset feed microstrip configuration. The pair of conductive feeds is arranged on the substrate in an orthogonal relationship and interact with the common patch to form two independent antenna elements which are non-interfering and orthogonally polarized. Preferably, the diversity antenna is housed within a low-profile protective casing to yield a patch-type antenna structure with orthogonal signal coverage. In operation, the independent signal feeds produced by the pair of antenna elements are delivered by corresponding feedlines to a diversity receiver for signal processing. Accordingly, the diversity receiver is able to minimize any cross-polarization effects present in either signal feed, thereby providing the diversity antenna with full, omnidirectional signal coverage.

### CROSS REFERENCE TO RELATED APPLICATIONS

The present invention claims the benefit under 35 U.S.C. 119(e) to U.S. Provisional Pat. Application No. 63/292,258, which was filed on Dec. 21, 2021, in the names of Robert J. Crowley et al.

### FIELD OF THE INVENTION

The present invention relates generally to antenna systems and, more particularly, to diversity antennas for use in diversity antenna systems.

### BACKGROUND OF THE INVENTION

In wireless communications, multi-path interference occurs as radio frequency (RF) waves reflect off objects located along the signal transmission path. Consequently, as an RF signal arrives at a receiver through a direct signal path, numerous indirect signal paths caused from reflections arrive at the receiver at slightly varying time intervals. This multi-path transmission of an RF signal creates interference, which can create cross-polarization of the RF signal (i.e., radiation orthogonal to the desired radiation plane). Due to cross-polarization of the RF signal, certain types of conventional RF antennas often experience deep null or dropout conditions in the received signal, which is highly undesirable.

To remedy the shortcomings associated with multi-path interference, an antenna diversity scheme is often implemented in which a network of independent antennas is positioned at separate locations and arranged at different angles within the designated area in order to improve coverage quality and reliability. The feed from each of the network of antennas is then typically transmitted to one or more receivers for signal processing. As such, systems which rely upon antenna diversity are utilized in a wide range of applications, from cellular communication systems to microphone systems used in performance venues, such as places of worship, sport venues, concert arenas, convention halls, and the like.

In order to operate in an optimal fashion, antenna systems of the type as described above require the user to precisely position and angle each of the network of antennas. Most notably, if at least two of the individual antennas are not oriented in orthogonal planes, signal dropouts and other harmful effects of cross-polarization remain at risk.

To resolve this issue, diversity antennas are well known and commonly utilized in the art. A diversity antenna is a unitary module which is constructed with two independent antennas that are fixedly arranged in a defined spatial relationship in order to improve the quality and reliability of wireless communications. Notably, through the use of two independent antennas, which are fixedly arranged in different radiation planes, the effects of multi-path interference are significantly reduced. As a result, a diversity antenna receiver in connection with the diversity antenna is able to process the multiple antenna feeds upon detecting unwanted effects, thereby resulting in an overall improvement in signal quality with fewer dropouts and noise.

For example, in U.S. Pat. No. 8,836,593 to R.J. Crowley et al., (hereinafter “the ‘593 patent”), a diversity antenna is described which comprises a fin-type blade antenna and a deployable dipole antenna that are arranged in an orthogonal relationship relative to one another, the disclosure of which is incorporated herein by reference. In use, the blade antenna is designated to receive RF energy that is vertically polarized, whereas the dipole antenna is designated to receive RF energy that is horizontally polarized. In this manner, the use of two independent antennas, configured in an orthogonal arrangement, significantly resolves cross-polarization fades and dropouts. Additionally, the consolidation of multiple antennas into a single device minimizes overall number of system components, including feedlines, stands, and the like, which would otherwise clutter the designated area.

Although widely used in the art, conventional diversity antennas tend to have a sizable profile. As a result, conventional diversity antennas (e.g., the diversity antenna disclosed in the ‘593 patent) are not typically surface mountable. As can be appreciated, certain indoor environments (e.g., conference rooms, offices, and small business venues) often require the use of antennas which are low profile and designed for mounting on a wall, ceiling, or other similar surface in an unobtrusive manner for functional and/or aesthetic reasons.

### SUMMARY OF THE INVENTION

It is an object of the present invention to provide a novel diversity antenna for use in a diversity antenna system.

It is another object of the present invention to provide a diversity antenna as described above which includes two independently operating antenna elements.

It is yet another object of the present invention to provide a diversity antenna as described above wherein the two independent antenna elements are configured to provide orthogonal signal coverage.

It is still another object of the present invention to provide a diversity antenna as described above which is designed to minimize the effects of signal cross-polarization resulting from multi-path interference.

It is another object of the present invention to provide a diversity antenna as described which has a low profile and is surface mountable.

It is yet another object of the present invention to provide a diversity antenna which has a limited number of parts, is inexpensive to manufacture, and is easy to use.

Accordingly, as one feature of the present invention, there is provided a diversity antenna for receiving radio frequency (RF) signals, the diversity antenna comprising (a) a single dielectric substrate having a front surface and a rear surface, (b) a single conductive patch disposed on the front surface of the dielectric substrate, (c) a first conductive feed disposed on the front surface of the dielectric substrate, and (d) a second conductive feed disposed on the front surface of the dielectric substrate, the second conductive feed extending on the dielectric substrate in an orthogonal relationship relative to the first conductive feed, (e) wherein the conductive patch and the first conductive feed together form a first antenna element for receiving RF signals, the first antenna element being vertically polarized, (f) wherein the conductive patch and the second conductive feed together form a second antenna element for receiving RF signals, the second antenna element being horizontally polarized.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings, wherein like reference numerals represent like parts:

FIG. 1 is a front top perspective view of a diversity antenna system constructed according to the teachings of the present invention;

FIG. 2 is front view of the diversity antenna shown in FIG. 1;

FIG. 3 is a front perspective view of the diversity antenna shown in FIG. 1, the diversity antenna being shown with an exploded outer casing in which the diversity antenna is preferably housed;

FIG. 4(a) is a graph of actual measurements of signal strength in relation to signal source angle received by a single, conventional, linearly polarized antenna;

FIG. 4(b) is a graph of actual measurements of signal strength in relation to signal source angle received by a diversity antenna with dual orthogonal antenna elements, the graph illustrating a notable improvement in reducing the effects of signal cross-polarization which is achieved by the diversity antenna;

FIGS. 5(a) and 5(b) are graphs of actual measurements of the azimuth radiation patterns for horizontally-polarized and vertically-polarized antenna elements, respectively, the graphs together illustrating the relative uniformity of signal gain in all directions that can be achieved by constructing a diversity antenna with dual orthogonal antenna elements; and

FIG. 6 is a graph of actual measurements of the electrical signal isolation between the pair of orthogonal antenna elements in the diversity antenna shown in FIG. 2.

### DETAILED DESCRIPTION OF THE INVENTION

### Diversity Antenna System 11

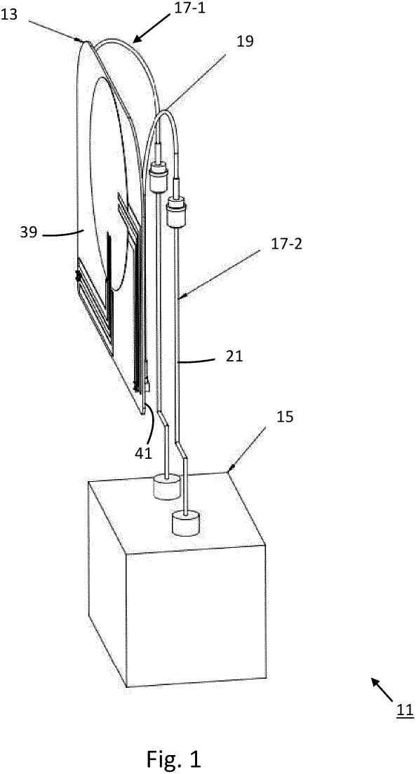

Referring now to FIG. 1, there is shown a diversity antenna system constructed according to the teachings of the present invention, the system being defined generally by reference numeral 11. As will be explained in detail below, system 11 is designed with a novel construction that ensures the reception of radio frequency (RF) signals in a wide range of directions and orientations with minimal risk of deep null or dropout conditions, which can result from signal cross-polarization.

As can be seen, diversity antenna system 11 comprises a diversity antenna 13 connected to a diversity antenna receiver 15 via a pair of feedlines 17-1 and 17-2. Each feedline 17 comprises a flexible, pigtail-type cable 19 which is connected to an associated antenna element of diversity antenna 13, as will be explained further below. In turn, a coaxial cable 21 connects the free end of an associated pigtail cable 19 to a corresponding port on receiver 15. As can be seen, coaxial cables 21 preferably run in a generally parallel relationship, which not only facilitates installation but also results in a relatively compact overall system design.

In use, the individual signal feeds derived from diversity antenna 13 are delivered by feedlines 17 to receiver 15. In response, receiver 15 processes the individual signal feeds in the correct phase relationship to yield an output signal with broad bandwidth and high gain. It is to be understood that receiver 15 is preferably in the form of any conventional high-performance wireless receiver with diversity reception, such as an SLX4 model diversity receiver manufactured and sold by Shure Incorporated of Chicago, Illinois.

As will be described in detail below, the unique construction of diversity antenna 13 serves as the principal novel feature of the present invention. In particular, diversity antenna 13 is constructed as a single patch-type antenna with dual orthogonal leads. As a result, diversity antenna 13 is able to uniformly receive RF signals from all directions relative thereto with minimal risk of deep null or dropout conditions created from signal cross-polarization.

### Diversity Antenna 13

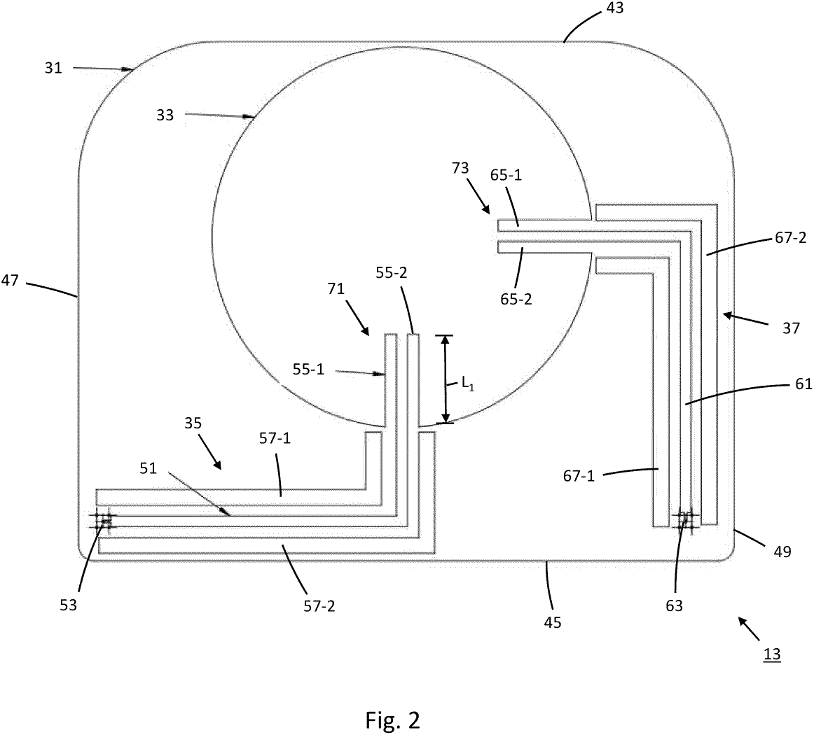

As referenced above, diversity antenna 13 comprises two independent, non-interfering, orthogonal antenna elements which together minimize the deleterious effects of multi-path signal interference in order to enhance the quality and reliability of wireless communications. More specifically, as shown in FIGS. 1 and 2, diversity antenna 13 comprises (i) a dielectric substrate 31, (ii) a single conductive patch 33 disposed on substrate 31, (iii) a first conductive feed 35 disposed on substrate 31, and (iv) a second conductive feed 37 disposed on substrate 31.

As will be explained further below, each of feeds 35 and 37 cooperates with common patch 33 to form an individual RF antenna element. As a principal feature of the present invention, first and second conductive feeds 35 and 37 are arranged on substrate 31 in a fixed orthogonal relationship relative to one another. As a result, two independent antenna elements are established which are non-interfering and orthogonally polarized, thereby providing diversity antenna 13 with orthogonal signal coverage.

Dielectric substrate 31 is preferably in the form of a single-sided printed circuit board (PCB) that is constructed of a suitable dielectric material, such as a glass-reinforced epoxy laminate. As can be seen, substrate 31 has a thin, generally rectangular shape with a flat front surface 39, a flat rear surface 41, a rounded top edge 43, a straight bottom edge 45, a left edge 47, and a right edge 49.

Single conductive patch resonator, or patch, 33 is formed on front surface 39 towards top edge 43. In the present embodiment, conductive patch 33 is circular and serves as the common load for each of the two independent orthogonal antenna elements. It should be noted that diversity antenna 13 is not limited to patch 33 having a circular configuration. Rather, it is to be understood that diversity antenna 13 could be designed with a conductive patch which is alternatively shaped (e.g., a square configuration) without departing from the spirit of the present invention.

First feed 35 is preferably has an inset feed microstrip design which includes a center, or inner, conductive trace, or microstrip, 51 formed on front surface 39. Center trace 51 is generally L-shaped with its distal end located at the corner defined by left edge 47 and bottom edge 45. Preferably, a plated thru-hole 53 extends through substrate 31 at the distal end of inner trace 51 and thereby enables a pigtail cable 19 to be electrically coupled to first feed 35 through rear surface 41.

As can be seen, center trace 51 extends along a portion of bottom edge 45 and projects radially inward onto patch 33. A pair of parallel radial notches 55-1 and 55-2 is formed in patch 33 so as to define a narrow strip in patch 33 which is contiguous with inner trace 51 and which defines the inset portion, or length, of feed 35. Additionally, first conductive feed 35 comprises a pair of L-shaped outer traces 57-1 and 57-2 which are formed on front surface 39 on opposite sides of and in a fixed spaced apart relationship relative to inner trace 51, each outer trace 57 terminating just prior to reaching the outer periphery of patch 33.

Similar to first feed 35, second feed 37 preferably has an inset feed microstrip design which includes a center, or inner, conductive trace, or microstrip, 61 formed on front surface 39. Center trace 61 is generally L-shaped with its distal end located at the corner defined by right edge 49 and bottom edge 45. Preferably, a plated thru-hole 63 extends through substrate 31 at the distal end of inner trace 61 and thereby enables a pigtail cable 19 to be electrically coupled to second feed 37 through rear surface 41.

As can be seen, center trace 61 extends along a portion of right edge 49 and projects radially inward onto patch 33. A pair of parallel radial notches 65-1 and 65-2 is formed in patch 33 so as to define a narrow strip in patch 33 which is contiguous with inner trace 61 and which defines the inset portion, or length, of feed 37. Additionally, second feed 37 comprises a pair of L-shaped outer traces 67-1 and 67-2 which are formed on front surface 39 on opposite sides of and in a fixed spaced apart relationship relative to inner trace 61, each outer trace 67 terminating just prior to reaching the outer periphery of patch 33.

It should be noted that conductive feeds 35 and 37 need not be limited to an inset feed microstrip design. Rather, it is to be understood that alternative types of feed microstrip configurations that are utilized in patch antennas (e.g., edge feeding microstrips) could be utilized in place thereof without departing from the spirit of the present invention.

Together, substrate 31, patch 33 and first feed 35 form a first antenna element 71 which is adapted to transmit and/or receive electromagnetic energy within the radio frequency spectrum. Due to the vertical orientation of inset portion on patch 33, first antenna element 71 is rendered vertically polarized.

In a similar fashion, substrate 31, patch 33 and second feed 37 together form a second antenna element 73 which is adapted to transmit and/or receive electromagnetic energy within the radio frequency spectrum. Due to the horizontal orientation of inset portion on patch 33, antenna element 73 is rendered horizontally polarized.

As previously noted, antenna elements 71 and 73 function as a pair of fully independent, insulated, and orthogonal antenna elements. Accordingly, any RF energy which is electrically super positioned on patch 33 is transmitted along each of feeds 35 and 37. It should be noted that each of feeds 35 and 37 has the ability to receive or radiate both vertically and horizontally polarized signals. However, the different signal polarizations are not received by feeds 35 and 37 at the same signal strength since each feed has a predominant signal polarization. Instead, the signal feed from each of antenna elements 71 and 73 is delivered to receiver 15 via its corresponding feedline 17. Diversity antenna receiver 15 then superimposes the two independent signal feeds, which may be of different signal strengths, in order to minimize the deleterious effects of multi-path signal interference that may be experienced by one of antenna elements 71 and 73.

For simplicity and ease of explanation, diversity antenna 13 is represented in FIGS. 1 and 2 without an outer housing. However, it is to be understood that diversity antenna 13 is preferably constructed with an outer housing in order to protect the sensitive electrical components of diversity antenna 13, create a sleek modular device, and facilitate surface mounting.

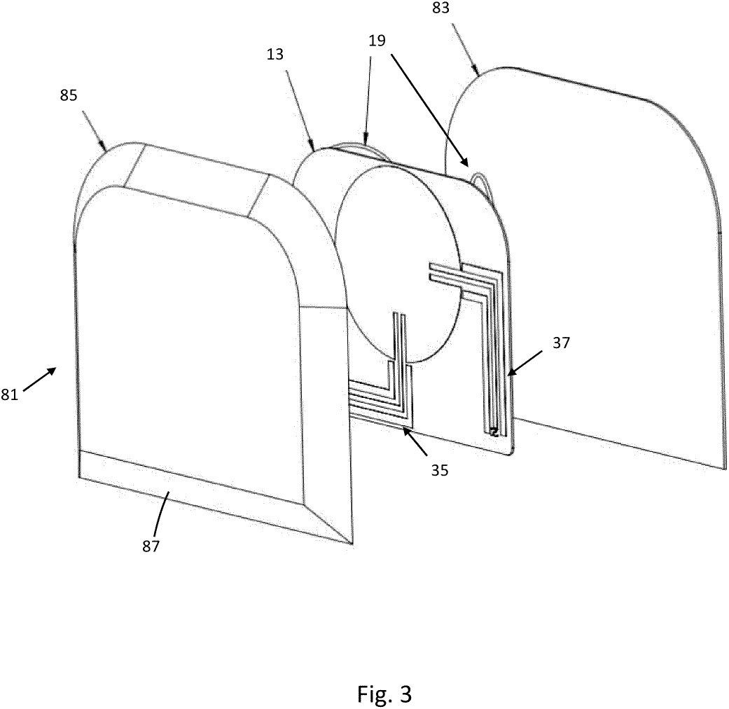

For example, in FIG. 3, diversity antenna 13 is shown with an outer protective casing, or housing, 81. As can be appreciated, outer protective housing 81 encloses diversity antenna 13 and facilitates surface mounting.

Outer casing 81 comprises a back case 83 and a front case 85 which together define an interior cavity in which diversity antenna 13 is retained. Each of back case 83 and front case 85 is preferably constructed of a rigid, durable, and inexpensive material, such as plastic, which is suitable for protecting diversity antenna 13.

Back case 83 is in the form of a generally planar member with the same general shape as antenna substrate 31, although slightly larger in size. The planar construction of back case 83 renders it suitable for flush mounting on a desired surface (e.g., a ceiling or wall).

Front case 85 has the same overall shape as back case 83 but is slightly recessed within its rear surface to receive diversity antenna 13. A beveled surface 87 extends along the periphery of front case 83 on its front surface to provide outer casing 81 with its streamlined and unobtrusive design.

As part of the assembly and installation process, back case 83 is fixedly mounted on the desired surface. With antenna 13 disposed within the cavity formed in its rear surface, front case 85 is secured to back case 83. Although not shown, matching fastening elements are preferably provided on back case 83 and front case 85 to allow for releasable snap-fit securement between parts. Casing 81 is preferably provided with a pair of small holes through which the distal ends of pigtail cables 19 can protrude once connected to substrate 31. As such, coaxial cables 21 can be internally routed through the mounting surface and protrude out therefrom in close proximity to protective casing 81 to facilitate connection to pigtail cables 19. In this manner, diversity antenna 19 can be electrically connected to diversity receiver 15 while housed within the surface-mounted, low profile, protective casing 81.

### Signal Quality Improvements Achievable Using a Diversity Antenna

It should be noted that diversity antennas with dual orthogonal antenna elements (e.g., diversity antenna 13) have been constructed and, in turn, tested to determine its effectiveness in reducing or eliminating deep cross-polarization nulls and reduce signal dropouts for a full 360 degrees of azimuthal coverage. For comparative purposes, a conventional, linearly, or single-plane, polarized antenna, hereinafter referred to simply as the comparative antenna, has been tested to determine its effectiveness in receiving the same test signal over a full 360 degrees of azimuthal coverage. The results of the aforementioned testing are detailed below. The following results are provided for illustrative purposes only and are not intended to limit the scope of the present invention.

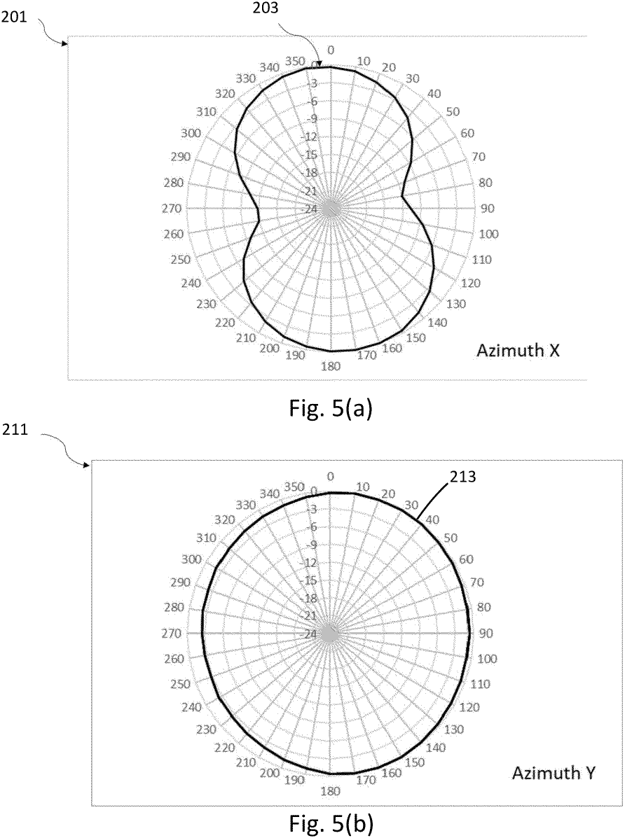

FIGS. 5(a) and 5(b) are actual graphs which illustrate signal strength relative to the linear polarization angle for a test signal received by each of the comparative antenna and a diversity antenna with dual orthogonal antenna elements, respectively. Together, the aforementioned graphs illustrate a notable increase in signal strength coverage that is achieved by the present invention.

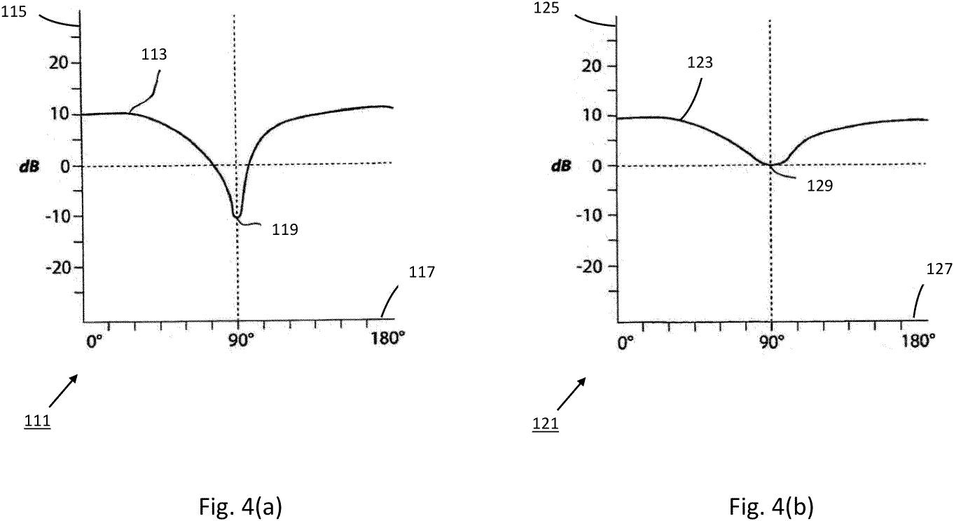

Specifically, in FIG. 4(a), a graph for the comparative antenna is shown, the graph being identified generally by reference numeral 111. In graph 111, a measured test signal 113 is represented along vertical axis 115 in terms of signal strength (dB) and along horizontal axis 117 in terms of the horizontal angle of the linear signal source (degrees). As can be seen, the comparative antenna experiences an undesired null condition 119 at an angle of 90 degrees. In the present example, null condition 119 results in a signal strength drop of 20 dB below its maximum signal strength. As can be appreciated, a 20 dB loss in signal strength is considerably high, and sufficient to produce a signal fade that can be heard as noise.

By comparison, in FIG. 4(b), a graph for a diversity antenna with dual orthogonal antenna elements (e.g., diversity antenna 13) is shown, the graph being identified generally by reference numeral 121. In graph 121, a measured test signal 123 is represented along vertical axis 125 in terms of signal strength (dB) and along horizontal axis 127 in terms of the horizontal angle of the linear signal source (degrees). As can be seen, a diversity antenna with dual orthogonal antenna elements effectively compensates for an undesired null condition 129 experienced at an angle of 90 degrees by combining the two independent orthogonally-polarized signal feeds together, thereby minimizing the effects of null condition 129. Notably, the effects of null condition 129 are reduced by approximately 10 dB, thereby resulting in a signal strength drop of only 10 dB below its maximum signal strength, which is a considerable improvement.

Referring now to FIGS. 5(a) and 5(b), there are shown vector plots of (i) the azimuthal radiation pattern for a horizontally-polarized antenna element (e.g., antenna element 73), and (ii) the azimuthal radiation pattern for vertically-polarized antenna element (e.g., antenna element 71), respectively. By superimposing the two radiation patterns, it is illustrated that a diversity antenna with dual orthogonal antenna elements (e.g., diversity antenna 13) would have a nearly uniform, 360-degree, radiation pattern for both horizontally and vertically polarized modes of operation, which is a principal object of the present invention.

In FIG. 5(a), an actual vector plot 201 of the azimuth radiation pattern 203 for a horizontally-polarized antenna element (e.g., antenna element 73) is shown. As can be seen, azimuth plane pattern 203 has two main radiation lobes at around 0 degrees and 180 degrees, with approximately 80 degrees of half-power beam width on each lobe. In FIG. 5(b), a vector plot 211 of the azimuth radiation pattern 213 for a vertically-polarized antenna element (e.g., antenna element 71) is shown. As can be seen, azimuth plane pattern 213 is nearly circular in shape, experiencing minimal field distortion (less than 3 dB) over 360 degrees of operation. Therefore, the superimposition of azimuth radiation patterns 203 and 213 illustrates that the two independent signal feeds generated by a pair of orthogonal antenna elements could be combined together to provide a diversity antenna with signal uniformity in all directions and thereby reduce the probability that a cross-polarization null effect would produce a significant signal strength drop in both signal feeds at the same moment.

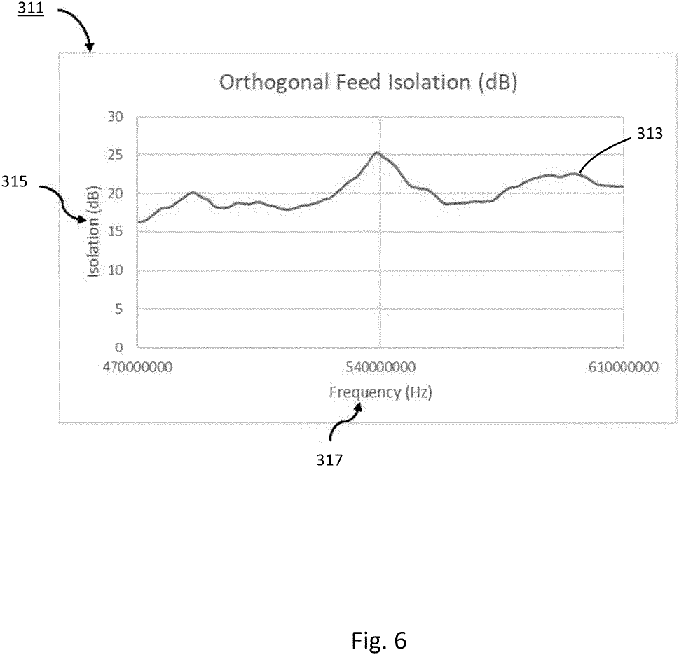

In FIG. 6, a graph depicting actual measurements of the degree of electrical signal isolation between orthogonal antenna elements 71 and 73 of diversity antenna 13 is shown, the graph being identified generally by reference numeral 311. In graph 311, an electrical isolation measurement 313 is represented along vertical axis 315 in terms of isolation strength (dB) and along horizontal axis 317 in terms of signal frequency (Hz). As can be seen, the average amount of electrical isolation between antenna elements 71 and 73 is greater than 20 dB across the designated frequency range. This amount of port-to-port electrical isolation between feeds 35 and 37 enables two independent antenna elements 71 and 73 to be constructed which share a common patch 33 and substrate 31.

### Performance of Diversity Antenna 13 Relative to Variable Factors

It has been found that certain environmental conditions and/or component materials may affect the performance of diversity antenna 13. Accordingly, diversity antenna 13 has been tested with respect to certain variable factors for evaluation purposes. The results of the aforementioned testing are detailed below. The following results are provided for illustrative purposes only and are not intended to limit the scope of the present invention.

For instance, it has been determined that the particular type of material of the surface on which diversity antenna 13 is ultimately mounted can affect its performance. Accordingly, the performance of diversity antenna 13 was tested in relation to certain types of materials which are commonly found in offices, conference rooms, and other small business venues. More specifically, diversity antenna 11 was tested while disposed against air, concrete, wallboard, and sheet metal, with air serving as a control against which other materials were compared.

As part of the test, diversity antenna 13 was disposed against each of the aforementioned surface materials while a transmitting antenna was rotated around the test surface from 0 to 180 degrees at a constant distance. The strength of the signal received by diversity antenna 13 was averaged and compared against the control. The signal strength received by diversity antenna 13 while mounted on wallboard was nearly identical to the control (i.e., air), as the measured signal loss was minimal (less than 1 dB). The measured signal loss with diversity antenna 13 mounted on concrete was slightly greater but nonetheless acceptable (approximately 3 dB). Lastly, the measured signal loss with diversity antenna 13 mounted on sheet metal was even greater (approximately 5 dB). As a result, it has been determined that diversity antenna 13 is suitable for mounting in a wide array of different office environments, but it is recommended that diversity antenna 13 be spaced away from metal surfaces to the greatest extent possible to optimize performance.

As another example, it has been determined that the particular geometry of conductive patch 33 and well as feeds 35 and 37 can affect the overall performance of diversity antenna 13. Notably, patch 33 serves as an antenna load which determines the lower bound of the frequency range for each of antenna elements 71 and 73. More specifically, an increase in the size of patch 33 results in a decrease in the lower bound of the frequency range for each of antenna elements 71 and 73. As shown below in Table 1, simply increasing the diameter of circular patch 33 results in a commensurate decrease in the lower bound of the antenna frequency range.

TABLE 1

| Patch Diameter (in) | Lower Bound (MHz) | Upper Bound (MHz) | Bandwidth (MHz) |
|---|---|---|---|
| 6 | 390 | 1598 | 1208 |
| 4.5 | 452 | 1605 | 1153 |

As can be seen, by decreasing the diameter of circular patch 33 by 1.5 inches, the lower bound of the antenna frequency range was increased by 62 MHz. However, the upper bound of the antenna frequency range only increased by 7 MHz, thereby resulting in a small overall reduction in the antenna bandwidth (55 MHz).

It has also been determined that modifying the inset length L₁ of feeds 35 and 37 affects the lower bound of the antenna frequency range. As shown below in Table 2, simply increasing the inset length of feeds 35 and 37 results in a commensurate increase in the lower bound of the antenna frequency range.

TABLE 2

| Inset Length (in) | Lower Bound (MHz) | Upper Bound (MHz) | Bandwidth (MHz) |
|---|---|---|---|
| 1.5 | 390 | 1598 | 1207 |
| 2.5 | 593 | 1565 | 972 |

As can be seen, increasing the inset length of feeds 35 and 37 by 1 inch correspondingly increases the lower bound of the antenna frequency range by 203 MHz. However, the upper bound of the antenna frequency range decreased by 32 MHz, thereby resulting in a significant overall reduction in the antenna bandwidth (235 MHz).

Lastly, it has been determined that modifying the feed length of feeds 35 and 37 (i.e., the non-inset portion of each feed) has the most significant effect on the upper bound of the antenna frequency range. As shown below in Table 3, decreasing feed lengths results in a sizable increase in the upper bound of the antenna frequency range.

TABLE 3

| Feed Length (in) | Lower Bound (MHz) | Upper Bound (MHz) | Bandwidth (MHz) |
|---|---|---|---|
| 4.7 | 452 | 1605 | 1153 |
| 3.25 | 492 | 1811 | 1319 |

As can be seen, decreasing the length of feeds 35 and 37 by 1.5 inches correspondingly increases the upper bound of the antenna frequency range by 206 MHz. Similarly, the feed length change caused the lower bound of the antenna frequency range to increase by only 40 MHz, thereby resulting in a significant overall increase in the antenna bandwidth (166 MHz).

The invention described in detail above is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A diversity antenna for receiving radio frequency (RF) signals, the diversity antenna comprising:
(a) a single dielectric substrate having a front surface and a rear surface;
(b) a single conductive patch disposed on the front surface of the dielectric substrate;
(c) a first conductive feed disposed on the front surface of the dielectric substrate; and
(d) a second conductive feed disposed on the front surface of the dielectric substrate, the second conductive feed extending on the dielectric substrate in an orthogonal relationship relative to the first conductive feed;
(e) wherein the conductive patch and the first conductive feed together form a first antenna element for receiving RF signals, the first antenna element being vertically polarized;
(f) wherein the conductive patch and the second conductive feed together form a second antenna element for receiving RF signals, the second antenna element being horizontally polarized.

2. The diversity antenna as claimed in claim 1 wherein each of the first and second conductive feeds extends directly into the conductive patch.

3. The diversity antenna as claimed in claim 2 wherein the first conductive feed extends vertically into the conductive patch.

4. The diversity antenna as claimed in claim 3 wherein the second conductive feed extends horizontally into the conductive patch.

5. The diversity antenna as claimed in claim 4 wherein each of the first and second conductive feeds extends into the conductive patch in electrical isolation from one another on the dielectric substrate.

6. The diversity antenna as claimed in claim 5 wherein each of the first and second conductive feeds has an inset feed microstrip configuration.

7. The diversity antenna as claimed in claim 6 wherein the first conductive feed comprises a first inner trace formed on the front surface of the dielectric substrate, the first inner trace extending into the conductive patch.

8. The diversity antenna as claimed in claim 7 wherein the first inner trace has a generally L-shaped configuration.

9. The diversity antenna as claimed in claim 8 wherein the first conductive feed additionally comprises a pair of parallel outer traces disposed on the dielectric substrate on opposite sides of the first inner trace.

10. The diversity antenna as claimed in claim 9 wherein the second conductive feed comprises a second inner trace formed on the front surface of the dielectric substate, the second inner trace extending into the conductive patch.

11. The diversity antenna as claimed in claim 10 wherein the second inner trace has a generally L-shaped configuration.

12. The diversity antenna as claimed in claim 11 wherein the second conductive feed additionally comprises a pair of parallel outer traces disposed on the dielectric substrate on opposite sides of the second inner trace.

13. The diversity antenna as claimed in claim 5 wherein the single conductive patch is generally circular in shape.

14. The diversity antenna as claimed in claim 13 wherein each of the first and second conductive feeds extends radially into the conductive patch.

15. The diversity antenna as claimed in claim 5 further comprising an outer housing for substantially enclosing the dielectric substrate.

16. The diversity antenna as claimed in claim 5 wherein the outer housing comprises a front case and a rear case which are releasably secured to one another.

17. The diversity antenna as claimed in claim 5 wherein the dielectric substrate is a single-sided printed circuit board (PCB).

18. The diversity antenna as claimed in claim 17 wherein the single-side PCB is constructed of a glass-reinforced epoxy laminate.
